(19) United States
(12) Patent Application Publication
(10) Pub. No.: US 2018/0364484 A1
(43) Pub. Date: Dec. 20, 2018

(54) IMAGE DISPLAY DEVICE AND OPTICAL ELEMENT

(71) Applicant: CANON KABUSHIKI KAISHA, Tokyo (JP)

(72) Inventor: Toshiyuki Yasuda, Yokohama-shi (JP)

(73) Assignee: CANON KABUSHIKI KAISHA, Tokyo (JP)

(21) Appl. No.: 15/747,056

(22) PCT Filed: Jul. 15, 2016
(86) PCT No.: PCT/JP2016/003354

§ 371 Date: Jan. 23, 2018

(30) Foreign Application Priority Data
Jul. 24, 2015 (JP) 2015-146837

(51) Int. Cl. G02B 27/01; H04N 13/344

(52) U.S. Cl. CPC G02B 27/0172; H04N 13/344; G02B 2027/0152; G02B 27/0149; G02B 2027/015; G02B 27/0176

(57) ABSTRACT

An image display device includes optical elements that are a left eye member and a right eye member. The image display device has an image display element that displays an image to an observer through the left eye member and the right eye member. The left eye member and the right eye member each have at least one part shape formed so as to avoid the contact with the nose of the observer. The surface of the at least one part shape is substantially parallel to the direction of a principal ray from the image display element.

### TECHNICAL FIELD

The present invention relates to an image display device having optical elements that are a left eye member and a right eye member, and optical elements that are a left eye member and a right eye member.

### BACKGROUND ART

For example, a head mounted display (HMD) is known as an image display device that displays an image displayed on an image display element, through left and right optical elements. An HMD is an image display device that is mounted on the head of an observer and that can provide a desired image to the observer.

It is desirable that image display devices such as HMDs be wearable by a wide variety of persons and the displayed image can be appropriately seen. In addition, in order to reduce the burden of an observer wearing an HMD, the whole device is desired to be reduced in size and weight.

In general, when trying to provide an image having a wide angle of view to an observer, the whole optical system including optical elements tends to increase in size and weight. Since an HMD is mounted on the head of an observer, the increase in size of the whole optical system is undesirable in view of the burden of the observer. Ways to suppress the increase in size of the whole optical system include reducing the exit pupil diameter of the optical system. However, in that case, the distance between the observer and the exit pupil needs to be reduced, and the left and right optical elements may touch the nose of the observer.

In order to solve the above problem, PTL 1 discloses removing parts that may touch the nose of an observer from optical elements that are a left eye member and a right eye member.

### CITATION LIST

### Patent Literature

PTL 1: Japanese Patent Laid-Open No. 2009-036835

In an image display device of PTL 1, parts that may touch the nose of an observer are removed from optical elements that are a left eye member and a right eye member, and therefore an image having a wide angle of view can be provided while preventing the increases in size of the whole optical system. However, some of rays that should form an image are lost owing to the partial removal of the optical elements, and the luminance of part of the displayed image decreases.

PTL 1 also discloses electrically compensating the decreased luminance, but does not mention any optical approach for suppressing the decrease in luminance of the displayed image, and suppression of the decrease in luminance of the displayed image is insufficient.

### SUMMARY OF INVENTION

The present invention provides an image display device having optical elements that are a left eye member and a right eye member in which the decrease in luminance of the displayed image is suppressed while preventing the optical elements from touching the nose of an observer.

### Solution to Problem

In an aspect of the present invention, an image display device includes optical elements that are a left eye member and a right eye member. The image display device has an image display element that displays an image to an observer through the optical elements. The optical elements each have at least one part shape formed so as to avoid the contact with the nose of the observer. The surface of the at least one part shape is substantially parallel to the direction of a principal ray from the image display element.

Further features of the present invention will become apparent from the following description of exemplary embodiments with reference to the attached drawings.

### BRIEF DESCRIPTION OF DRAWINGS

FIG. 1 shows the configuration of an image display device according to a first embodiment.

FIG. 2 shows part of a principal ray passing through a prism body.

FIG. 3 shows the shape of the prism body.

FIG. 4 shows the vignetting of an effective bundle of rays forming a principal ray.

FIG. 5 shows the configuration of a head mounted image display device according to a second embodiment.

FIG. 6 shows the configuration of a handheld image display device according to the second embodiment.

FIG. 7A shows the image display portion in the second embodiment.

FIG. 7B shows the image display portion in the second embodiment.

FIG. 7C shows the image display portion in the second embodiment.

FIG. 8 shows the lower back of the image display portion in the second embodiment.

### DESCRIPTION OF EMBODIMENTS

### First Embodiment

Embodiments of the present invention will now be described with reference to the drawings.

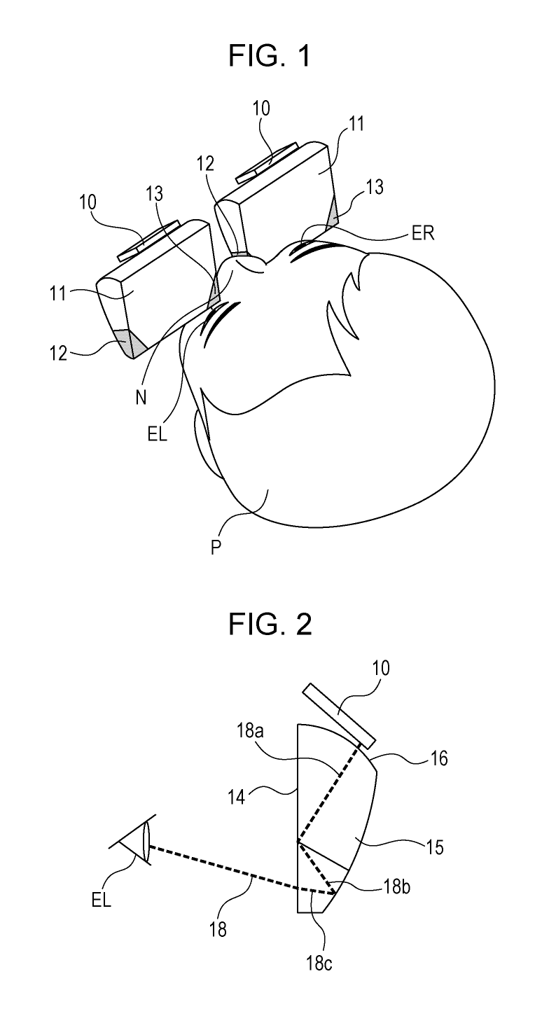

FIG. 1 shows the configuration of an image display device according to a first embodiment. An image display element 10 is disposed in front of the left eye EL of an observer P, and an optical element that is a prism body 11 is disposed between the image display element 10 and the left eye EL. The same image display element 10 as that on the left eye side is disposed in front of the right eye ER of the observer P, and an optical element that is the same prism body 11 as that on the left eye side is disposed between the image display element 10 and the right eye ER. That is, the optical elements are a left eye member and a right eye member. The image display elements 10 and the prism bodies 11 are collectively referred to as eyepiece optical system. The prism bodies 11 have a part shape such that nose side parts 12 and 13 are removed. The nose side parts 12 and 13 are removed for the purpose of avoiding interference (contact) between the nose N of the observer P and the left and right prism bodies 11. The prism bodies 11 in this embodiment have a bilaterally symmetrical shape. Because of a bilaterally symmetrical shape, the left and right prism bodies 11 can be manufactured in the same manufacturing process, and the manufacturing cost can be reduced.

FIG. 2 shows part of a principal ray passing through the prism body in the first embodiment. The prism body 11 mainly has three large surfaces: an A surface 14, a B surface 15, and a C surface 16. An image emitted from the image display element 10 passes through the inside of the prism body 11, and is reflected twice by the A surface 14 and the B surface 15, and the image of the image display element 10 is thereby enlarged.

The principal ray 18 is emitted from the lower right corner of the display surface of the image display element 10. The principal ray 18 enters through the C surface 16. The principal ray at this time is denoted by 18a. After that, the principal ray 18a travels to the A surface 14. Because the principal ray 18a is at a shallow angle to the A surface 14, the principal ray 18a is totally reflected by the A surface 14. After the reflection, the principal ray 18a becomes a principal ray 18b, and reaches the B surface 15. Because an aluminum vapor-deposited film is formed on the B surface 15, the principal ray 18b is reflected by the B surface 15. Then, the principal ray 18b becomes a principal ray 18c, exits through the A surface 14, and is guided to the eye of the observer.

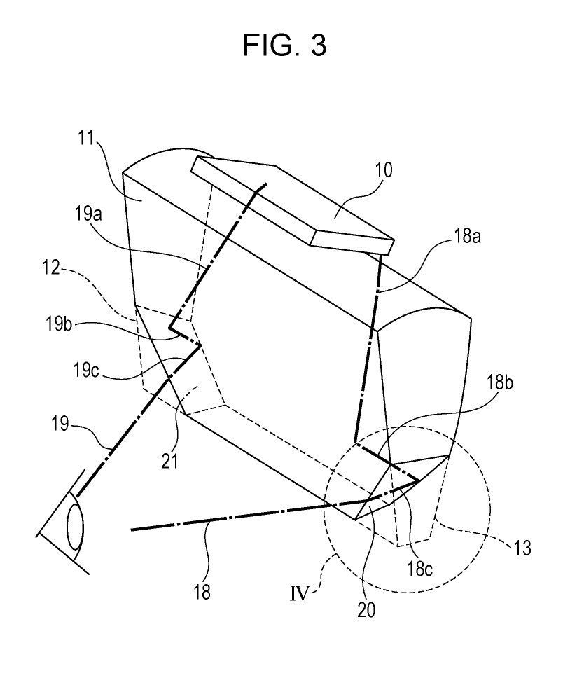

FIG. 3 shows the shape of the prism body in this embodiment. The surface 20 is a surface that forms part of the nose side part 13, and is a nose side removal surface. The direction of the principal ray 18c is parallel to the nose side removal surface 20, and the principal ray 18c is located on the nose side removal surface 20. The nose side removal surface 20 is painted black. This is for the purpose of blocking unwanted rays from entering through the nose side removal surface 20, and preventing image quality deterioration such as flare and ghost images due to internal reflection in the prism body 11 on the nose side removal surface 20. Instead of painting black, an optical thin film such as an aluminum vapor-deposited film or an antireflection film may be formed for the same purpose.

The principal ray 19 is emitted from the lower left corner of the display surface of the image display element 10. Since the prism body 11 has a bilaterally symmetrical shape, the principal ray 19 is guided to the eye of the observer through an optical path symmetrical to the optical path of the principal ray 18. The surface 21 is a surface that forms part of the nose side part 12, and is a nose side removal surface. The principal ray 19c is parallel to the nose side removal surface 21, and the principal ray 19c is located on the nose side removal surface 21. The nose side removal surface 21 is painted black to prevent ghost images due to internal reflection of unwanted rays and to block light from entering from the outside of the effective optical path.

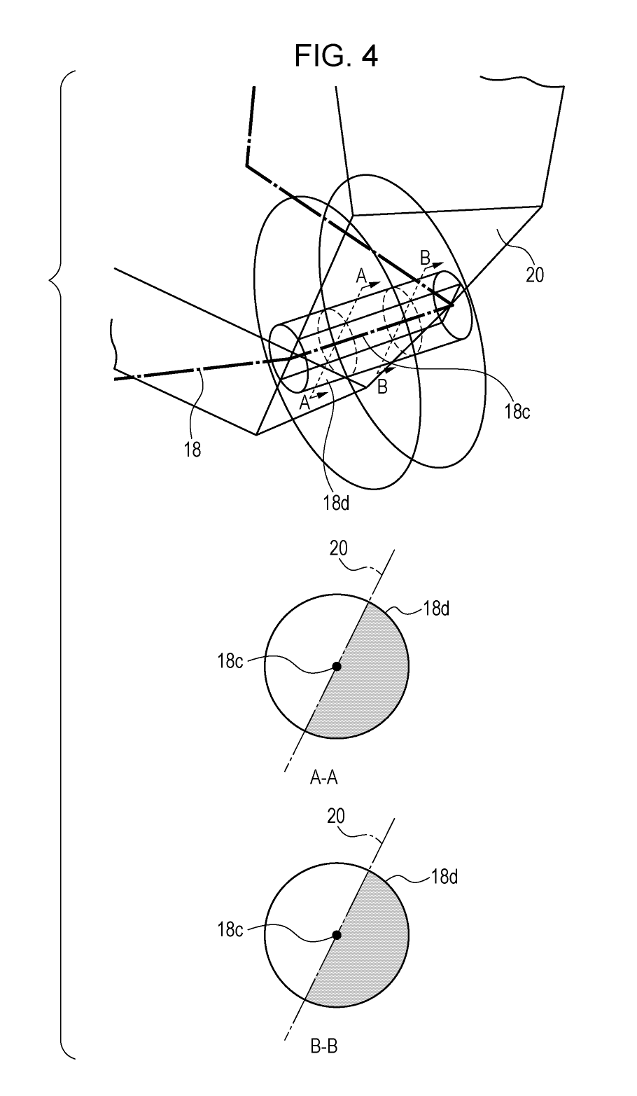

FIG. 4 shows the vignetting of an effective bundle of rays forming a principal ray in this embodiment. In FIG. 4, the part IV of FIG. 3 is enlarged. The effective bundle of rays 18d is an effective bundle of rays of the principal ray 18c, and planes (cross-sections) perpendicular to the principal ray 18c are shown. In the section A-A, the hatched region on the right side of the nose side removal surface 20 shows part of the bundle of rays being vignetted by the nose side removal surface 20. Since the principal ray 18c is located on the nose side removal surface 20, in the section A-A, the vignetted area is a half of the area of the effective bundle of rays. Similarly, in the section B-B, the hatched region on the right side of the nose side removal surface 20 shows part of the bundle of rays being vignetted by the nose side removal surface 20. In the section B-B, since the principal ray 18c is located on the nose side removal surface 20, the vignetted area is a half of the area of the effective bundle of rays. That is, the vignetting of the effective bundle of rays 18d forming the principal ray 18c is a half at any cross-section, and when the principal ray is parallel to the nose side removal surface 20, the amount of vignetting is the same at any cross-section. Therefore, when the principal ray is parallel to the nose side removal surface, the nose side removal surface is the most efficient as a removal surface.

Since the prism body 11 has a bilaterally symmetrical shape, part of the effective bundle of rays including the principal ray 19 is vignetted by the nose side removal surface 21 also in the nose side part 12 on the left side of the prism body 11. The rate of vignetting is a half of the effective light beam consisting the principal ray 19c, and the amount of vignetting of the effective bundle of rays forming the principal ray 19c is the same at any cross-section. In the above display optical system, prism bodies 11 are disposed at positions corresponding to both left and right eyes.

As described above, parts of the prism bodies 11 that are near the nose are removed at the nose side removal surfaces 20 and 21 such that the principal rays 18c and 19c nearest to the nose side removal surfaces 20 and 21 are parallel to the nose side removal surface 20 and 21. Thereby, a display optical system can be achieved in which prism bodies 11 are unlikely to interfere with the nose of an observer, and the decrease in the amount of light of the observed display image is minimized.

Although, in this embodiment, the principal rays 18c and 19c are parallel to the nose side removal surfaces 20 and 21, respectively, the present invention is not limited to complete parallelism. A case in which the angle between the principal ray 18c and the nose side removal surface 20 is 5 degrees is within the range of “substantially parallel” in this embodiment. Suppose, for example, a case in which the angle between the principal ray 18c and the nose side removal surface 20 is 5 degrees, and the maximum thickness of the prism body 11 near the left and right nose side removal surfaces 20 and 21 is 5 mm. In that case, the amount of vignetting of the effective bundle of rays is larger than when the principal ray 18c is parallel to the nose side removal surface 20 by 5*tan (5 deg)=0.437 [mm]. However, a margin of an optical effective bundle of rays of 0.5 mm is generally allowed, and 0.437 mm is within this range. Therefore, the influence of the decrease in the amount of light of the observed image is small.

### Second Embodiment

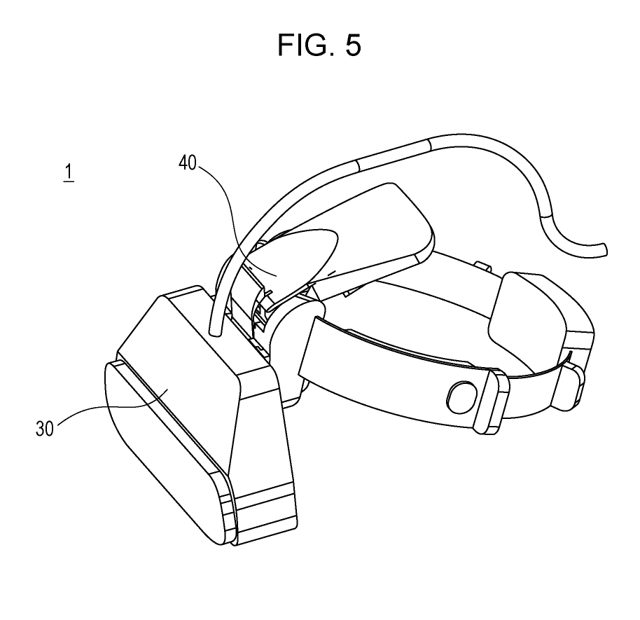

FIG. 5 shows the configuration of a head mounted image display device. The display optical system described in the first embodiment is applied to a head mounted image display device 1. The head mounted image display device 1 includes an image display portion 30 having a display optical system therein, and a mounting portion 40 mounted on the head.

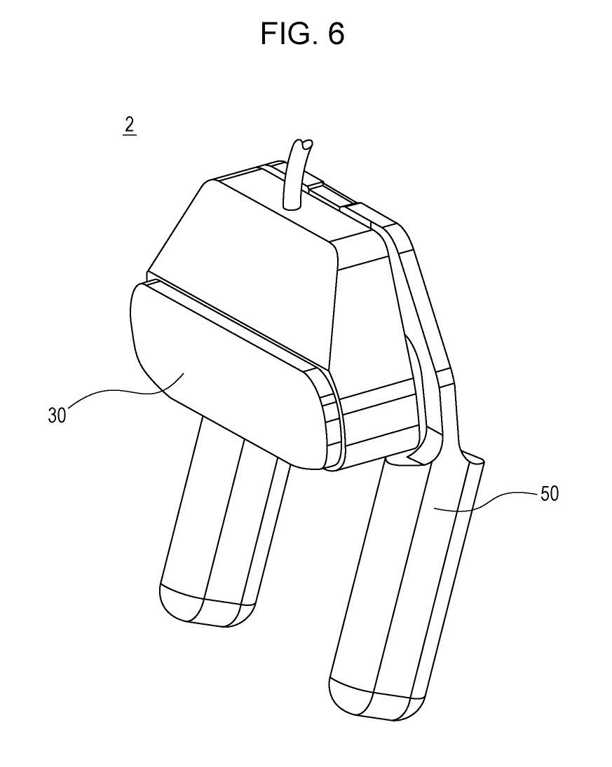

FIG. 6 shows the configuration of a handheld image display device. The display optical system described in the first embodiment is applied to a handheld image display device 2. The handheld image display device 2 includes an image display portion 30 having a display optical system therein, and a handheld portion 50 held by the hands of an observer.

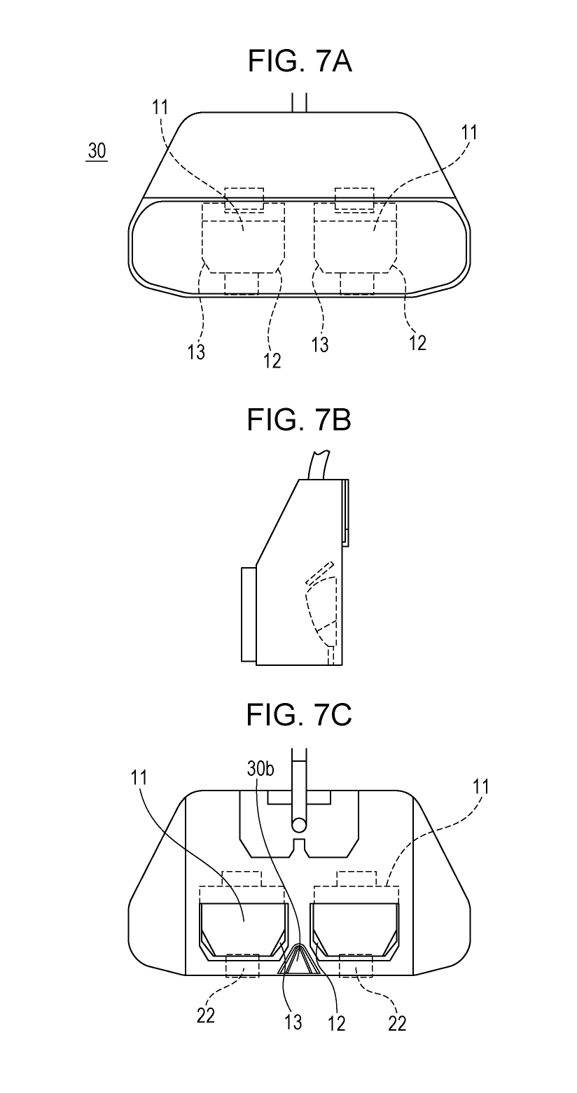

FIGS. 7A to 7C show the image display portion 30. FIG. 7A is a front view, FIG. 7B is a right side view, and FIG. 7C is a back view. The prism bodies 11 are disposed observably by both left and right eyes, and are surrounded by an exterior member. The central part of the image display portion 30 is recessed, and an exterior nose avoiding portion 30b that does not interfere with the nose of the observer is formed.

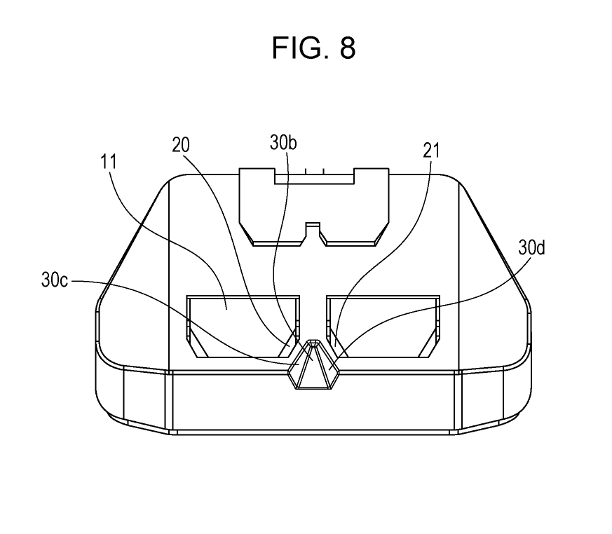

FIG. 8 shows the lower back of the image display portion. The exterior nose avoiding portion 30b is provided with an exterior nose avoiding surface 30c and an exterior nose avoiding surface 30d. The exterior nose avoiding surface 30c is parallel to the nose side removal surface 20 of the prism body 11 on the left eye side, and the exterior nose avoiding surface 30d is parallel to the nose side removal surface 21 of the prism body 11 on the right eye side. Therefore, the exterior nose avoiding portion 30b can be large such that it touches the prism bodies 11, and the exterior nose avoiding portion 30b can be maximized without interfering with the prism bodies 11.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-146837, filed Jul. 24, 2015, which is hereby incorporated by reference herein in its entirety.

1. An image display device comprising optical elements that are a left eye member and a right eye member,
wherein the image display device has an image display element that displays an image to an observer through the left eye member and the right eye member,
the left eye member and the right eye member each have at least one part shape formed so as to avoid the contact with the nose of the observer, and
the surface of the at least one part shape is substantially parallel to the direction of a principal ray from the image display element.

2. The image display device according to claim 1, wherein the left eye member and the right eye member each have a bilaterally symmetrical shape.

3. The image display device according to claim 1, wherein the at least one part shape comprises at least two part shapes.

4. The image display device according to claim 1, wherein the surface of the at least one part shape is subjected to light blocking treatment.

5. The image display device according to claim 1, wherein an optical thin film is formed on the surface of the at least one part shape.

6. The image display device according to claim 5, wherein the optical thin film is an aluminum vapor-deposited film.

7. The image display device according to claim 1, further comprising a mounting portion for mounting the image display device on the head of the observer.

8. The image display device according to claim 1, further comprising a handheld portion held by the hands of the observer.

9. The image display device according to claim 1, wherein the optical elements are prism bodies.

10. The image display device according to claim 1, wherein the angle between the surface of the at least one part shape and the direction of a principal ray from the image display element is 5 degrees.

11. Optical elements that are a left eye member and a right eye member and that guide light from an image display element to the eyes of an observer,
wherein the left eye member and the right eye member each have at least one part shape formed so as to avoid the contact with the nose of the observer, and
the surface of the at least one part shape is substantially parallel to the direction of a principal ray from the image display element.
